(19) United States
(12) Patent Application Publication
(10) Pub. No.: US 2025/0050394 A1
(43) Pub. Date: Feb. 13, 2025

(54) SOLAR PANEL RECYCLING

(71) Applicant: Worcester Polytechnic Institute, Worcester, MA (US)

(72) Inventors: Yan Wang, Acton, MA (US); Xiaotu MA, Worcester, MA (US); Owen Wang, Worcester, MA (US)

(21) Appl. No.: 18/800,633

(22) Filed: Aug. 12, 2024

Related U.S. Application Data
(60) Provisional application No. 63/531,918, filed on Aug. 10, 2023.

(51) Int. Cl. B09B 3/80; B09B 3/38; B09B 3/70; B09B 101/15; C01B 33/18

(52) U.S. Cl. CPC B09B 3/80; B09B 3/38; B09B 3/70; C01B 33/18; B09B 2101/15; C01P 2002/72; C01P 2006/80

(57) ABSTRACT

A recycling process for exhausted, end-of-life solar panels achieves substantial recovery of silicon and silver, as well as other materials, from a recycling stream of discarded solar panels. Agitation and shredding of the solar panels yield a granular mass, which can be separated by particle size to yield the silicon rich solar cell material. Leaching with a strong base such as sodium hydroxide draws the silicon into the leach solution. Filtration of the leach solution draws off the silicon-rich solution and allows filtration of other valuable materials such as silver. Addition of an acid such as hydrochloric acid to the leach solution then precipitates the silicon into a nano silica powder of in the form of high purity silicon dioxide. The high purity silicon dioxide provides raw materials for recycled solar panels, lithium-ion batteries and other uses depending on the purity.

### RELATED APPLICATIONS

This patent application claims the benefit under 35 U.S.C. § 119 (e) of U.S. Provisional Patent App. No. 63/531,918, filed Aug. 10, 2023, entitled “SOLAR PANEL RECYCLING,” incorporated herein by reference in entirety.

### BACKGROUND

Solar panels have gained increasing popularity with the modern trend towards renewable energy sources. As solar panels reach the end of their approximately 25 year useful life cycle, end-of-life solar panels enter the waste, and preferably recycling streams. There are also manufacturing scraps during solar panel fabrication. Raw materials and chemical processes employed in solar panel fabrication presents challenges for recycling. The solar cells are sandwiched between multiple layers of encapsulant which is layered between a glass panel and back sheet to ensure a weatherproof seal, which aids in longevity but can present challenges in separation of the constituent elements for recycling.

### SUMMARY

A recycling process for exhausted, end-of-life solar panels achieves substantial recovery of silicon and silver, as well as other materials, from a recycling stream of discarded solar panels or manufacturing scraps. Agitation and shredding of the solar panels yield a granular mass, which can be separated according to particle size to yield the silicon rich solar cell material. Leaching with a strong base such as sodium hydroxide draws the silicon into the leach solution. Filtration of the leach solution draws off the silicon-rich solution and allows filtration of other valuable materials such as silver. Addition of an acid such as hydrochloric acid to the leach solution then precipitates the silicon into a nano silica powder in the form of high purity silicon dioxide. The high purity silicon dioxide provides raw materials for recycled solar panels, lithium-ion batteries and other uses depending on the purity.

Configurations herein are based, in part, on the observation that the increasing deployment of solar panels for replacing fossil fuel energy sources will result in a corresponding increase in solar panel waste. This poses a serious challenge, as PV panels contain toxic materials such as lead, which can pollute the environment when dumped in landfills. Moreover, they contain valuable materials that could be recycled into new solar cells, but these resources are largely being wasted. Unfortunately, conventional approaches to solar panel recycling suffer from the shortcoming that high heat approaches and potentially hazardous solvents are often employed to target specific portions of the solar panel assembly. These energy intensive processes introduce additional environmental concerns counter to the recycling benefit they are intended to provide. Further, conventional approaches, particularly with respect to silicon, do not render a sufficiently pure silicon product for new solar panels. Accordingly, configurations herein substantially overcome the shortcomings of conventional approaches by employing a low heat process and moderate concentrations of safe chemicals that produces a highly pure (99.99%-99.9999%) silicon for downstream manufacturing.

In further detail, configurations herein demonstrate a method for recycling solar panels for obtaining purified silicon by agitating a recycling stream of solar panels for generating a granular mass of silicon based powders, and adding a base to the granular mass to form a leach solution for leaching silicon from the granular mass. An acid is then added to the leach solution to reduce the pH of the leach solution for precipitating recycled silicon in the form of a silica (SiO₂) powder.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of the disclosed approach for recycling solar panels and yielding highly pure nano silica powder;

FIG. 2A shows a process flow of the disclosed approach for recycling solar panels;

FIG. 2B shows a recycling environment and apparatus suitable for use with the disclosed approach of FIG. 2A;

FIG. 3 shows an X-Ray Diffraction (XRD) of the granular mass including Si and Ag in the environment of FIG. 2B;

FIGS. 4A-4D show leaching parameters and effectiveness of leaching with a strong base as in FIGS. 1-3; and

FIG. 5 shows an XRD analysis of the recovered SiO₂ using the approach of FIGS. 1-3.

### DETAILED DESCRIPTION

The description below describes several configurations associated with the approach. Examples based on an experimental context are disclosed to illustrate the technical content of solar panel recycling. Various substitutions of the particle sorting, leach agent base, and precipitation acid will be apparent to those of skill in the art.

As the accumulation of waste from solar panels and solar scraps rapidly increases, recycling these materials has become increasingly critical. Unfortunately, the complexity of disassembling solar panels often renders the recycling process unprofitable due to the low value of the recovered products, resulting in high costs and discouraging economic interest. Although numerous studies have sought to simplify the disassembly process and enhance the purity of the recovered products, these solutions often involve costly, toxic, and complex methods. In response, the disclosed approach introduces an environmentally green recycling technique using a straightforward alkaline leaching process. This method allows for the efficient recycling and refining of solar cells, yielding high-purity SiO₂ (99.994%) with a recycling rate of 92.74% and generating hydrogen gas as a green byproduct. A preliminary cost analysis indicates that this process holds substantial commercial potential and profitability. The proposed technique offers a new pathway towards making renewable energy sources more sustainable and economically feasible.

Conventional approaches to solar panel recycling attempts are burdened by high heat/energy requirements and strong solvents employed. Due to the difficulty of solar panel disassembly, conventional approaches have sought to use mechanical methods to shred the glass and solar cells. The glass pieces and mixed solar cell powder are separated by sieving. However, these conventional products are typically sold as low-grade materials with limited value. For instance, conventional approaches employ a purely mechanical process to reintegrate clean glass, metal, plastic, and aluminum into the supply chain. Unfortunately, in this approach, the silicon components are often overlooked due to the challenges in obtaining pure silicon. As a result, recycled silicon powders are frequently repurposed in the low-grade applications, such as cement and concrete, leading to a significant loss of value in the recycling process. While mechanical methods currently dominate the solar panel recycling industry due to their simplicity and cost-effectiveness, there is a clear need for more sophisticated techniques to maximize the value of recycled materials.

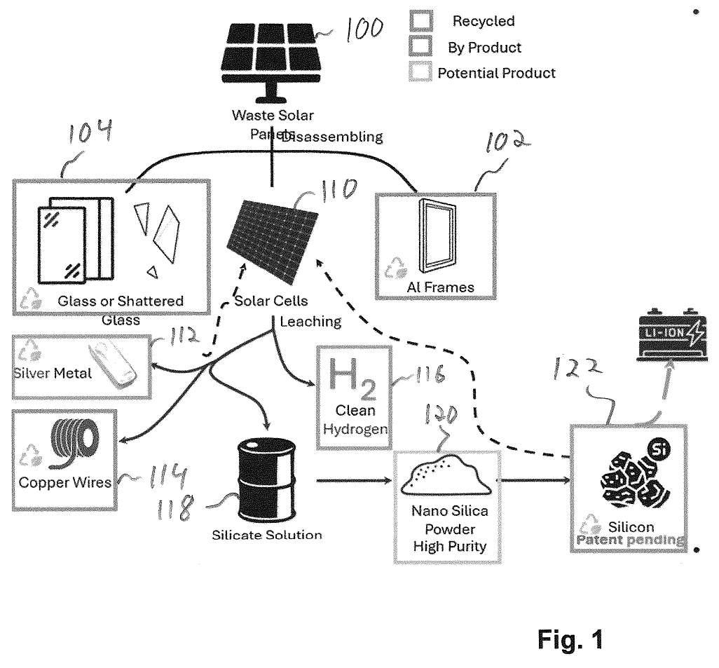

FIG. 1 is a context diagram of the disclosed approach for recycling solar panels and yielding highly pure nano silica powder. Referring to FIG. 1, from a recycling stream 100 of solar panels, major physical components are preferable disassembled into the casing and aluminum frames 102, glass 104, and the actual solar panels 110 containing a grid or array of solar cells, depending on the physical construction. A leach process separates valuable metals such as silver 112, copper 114 from electrical contacts, and a silicon rich leach solution 118, while also generating hydrogen gas 116 which can be recovered or vented. Precipitation of the leach solution 118 through pH adjustment yields a granular mass 120 of high purity silica (SiO₂) for downstream use 122 in new solar panels, Li-ion batteries, and other uses.

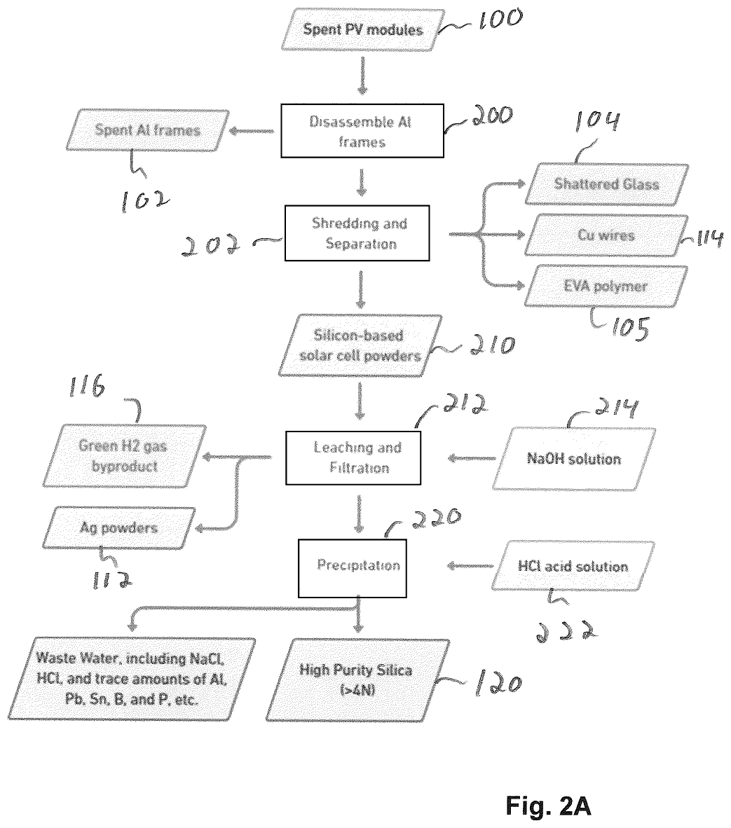

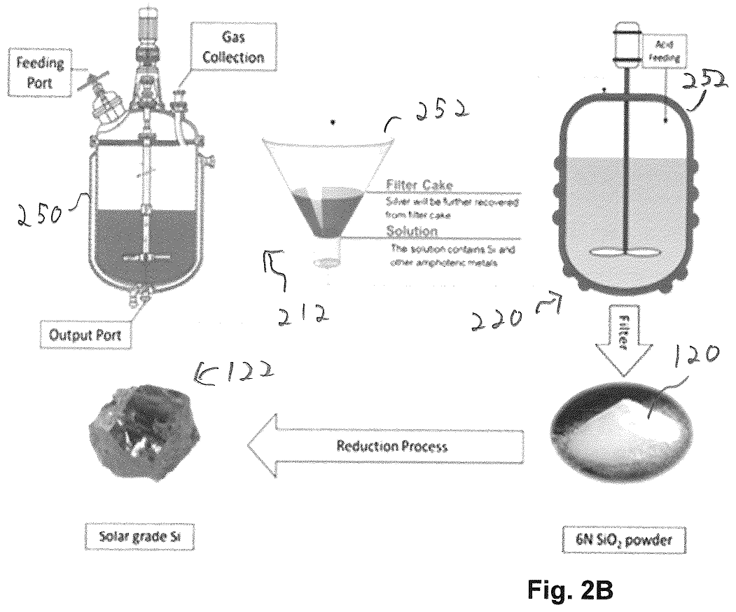

FIG. 2A shows a process flow of the disclosed approach for recycling solar panels. Referring to FIGS. 1 and 2A, a chemical leaching method is described for recycling solar panels 110 for obtaining purified silicon. The silicon-based solar panels are first disassembled, at step 200, to remove the aluminum frames 102. Next, the recycling stream of solar panels 110 is agitating for generating a granular mass of silicon based powders 210, as shown at step 202. The broken glass 104, copper wires 114, and Ethylene-Vinyl Acetate (EVA) 105, a common adhesion/encapsulating polymer, are then separated by sieving due to their different particle sizes. The resulting powder primarily consists of a granular mass 210 of silicon-based solar cells, including components such as Si, Ag, Al, and others. Generally, the solar cell particles containing silicon are smallest. The initial step in the recycling process involves leaching the silicon wafer particles from the solar cells 110, which may first undergo a ball milling procedure at around 400 rpm for 1-10 hours.

An initial impurity removal process may be employed. Such a step involves an acid wash of the solar cell particles for removing impurities such as B, Cu, Al, P, Na, Pb, Fe, S, Ag.

Once separated, a strong base is added to the granular mass 210 to form a leach solution for leaching silicon from the granular mass 120, as shown at step 212. In the example configuration, the silicon-based solar cells 110, in one piece or shredded powders, are put into a sodium hydroxide 214 solution where Si is dissolved, leaving behind the silver 112 which can be filtered out and producing the byproduct of hydrogen (H₂) gas 116. Both silver and H₂ gas can be collected and recovered for other applications.

At step 220, an acid is added to the leach solution to reduce the pH of the leach solution for precipitating recycled silicon. In the example configuration, hydrochloric acid 222 is added, causing only the sodium silicate to precipitate, leaving a relatively pure silica powered in the form SiO₂ which can be filtered out and dried. The overall recycling rate of Si is around 92.74% with a high purity SiO₂ of 99.994%.

In the example above, the strong base is a sodium hydroxide solution having a concentration between 5%-25%, however other bases may be employed to leach/dissolve the silicon. While addition of sodium hydroxide generally leaches Si into the leach solution, it is most effective to achieve a molar ratio of silicon to sodium hydroxide in the leach solution between 1:2 and 1:2.4. This also generally has an effect of raising the pH.

The acid is typically hydrochloric acid, such that the hydrochloric acid reduces the pH of the leach solution to between 1.0-4.0, however other acids may be employed, such as nitric acid and sulfuric acid, for example. In particular, the pH of the leach solution is preferably reduced to lower than 4, and in particular between 1 and 2, for precipitating the recycled silicon while maintaining residual aluminum in solution. Other suitable acids may be employed, however it is preferable to avoid hydrofluoric acid, as in conventional approaches, due to the hazardous nature.

This method improves upon conventional approaches by employing inexpensive and readily available chemical agents such as hydrochloric acid and sodium hydroxide at safe concentrations. These solutions are also not as harmful as organic solvents or hydrofluoric acid associated with the conventional approaches. Also, this process is more universal than preexisting requires methods which require stringent control of time to prevent over-etching. The disclosed process can be applied with little to no modification regardless of the manufacturer of the silicon-based panel or solar cell type, as generally silicon-based solar cells result in the silicon rich particle materials but differ in design.

FIG. 2B shows a recycling environment and apparatus suitable for use with the disclosed approach. Referring to FIGS. 1-2B, a containment or enclosure 250 receives the granular mass including silicon resulting from agitating the solar panels 110 from a waste stream of discarded solar panels. A strong base such as sodium hydride is combined with the granular mass in the enclosure 250 for inducing dissolution of at least the Si for subsequent filtration, as in step 212. Leaching is preferably conducted within a polytetrafluoroethylene (PTFE) reaction container to prevent contamination from glass beakers. Once dissolved, the leach solution 118 passes through a filter 252 or sieve, where a filter cake receives undissolved solids such as silver, and the leach solution 118 with the dissolved silicon drains into a precipitation containment 252. The precipitation containment 252 adjusts the pH using hydrochloric or other acid to reduce the pH for inducing precipitation of the silicon, as in step 220. The precipitated silicon 120 is gathered in a granular SiO₂ powder of around 99.994% purity, and undergoes further purification for generation of solar grade silicon 122 having a purity of 99.9999%.

The leach process at step 212 occurs according to the following equations:

2NaOH+Si+H₂O=Na₂SiO₃+2H₂↑ (1)

12NaOH+Si₃N₄=3Na₄SiO₄+4NH₃↑ (2)

2NaOH+2Al+2H₂O=2NaAlO₂+3H₂↑ (3)

2NaOH+2Al₂O₃=2NaAlO₂+H₂O (4)

To optimize leaching efficiency, several parameters are significant: temperature settings ranging from 25° C. to 100° C., varying molar ratios of silicon to sodium hydroxide from 1:2 to 1:2.4, reaction times from 30 minutes to 5 hours, and sodium hydroxide solution concentrations from 5% to 25% by weight. Following the leaching process, the solution and the residual solid powder are separated and collected using a polyethersulfone (PES) membrane filter.

After the leaching process at 212, the pH of the solution is rapidly decreased to 1-4 to precipitate the silicon dioxide while keeping the aluminum dissolved in the solution. This selective precipitation at step 220 allows for the efficient separation of silicon dioxide from aluminum. The precipitated silicon dioxide is then filtered off and subjected to further purification. It is washed with additional hydrochloric acid and deionized (DI) water, which helps to eliminate any residual aluminum, ensuring the purity of the silicon dioxide. This step is helpful for producing high-quality silicon dioxide suitable for various industrial applications, enhancing the value of the recycled material. The precipitation process 220 involves following chemical reactions:

$${Na}_{2} {SiO}_{3} + 2 HCl = 2 NaCl + {H}_{2} {SiO}_{3} \qquad ( 5 )$$

$${H}_{2} {SiO}_{3} {\to }^{Polymerized and dried} {SiO}_{2} * {x H}_{2} O \qquad ( 6 )$$

$${NaAlO}_{2} + HCl + {H}_{2} O = NaCl + A {l ( OH )}_{3} ↓ \qquad ( 7 )$$

$$Al {( OH )}_{3} + 3 HCl = {AlCl}_{3} + 3 {H}_{2} O \qquad ( 8 )$$

Other considerations regarding the leaching 212 and precipitation 220 steps in particular define a versatile procedure compatible with various types of silicon-based solar cells and incorporates mechanical disassembly techniques. Preferable input chemicals include NaOH and HCl solutions, yet the output materials include most or all usable components of PV (photovoltaic solar panel) modules, demonstrating a highly efficient solar recycling process. Wastewater which may contain traces of certain toxic metals may be effectively managed due to the low concentration.

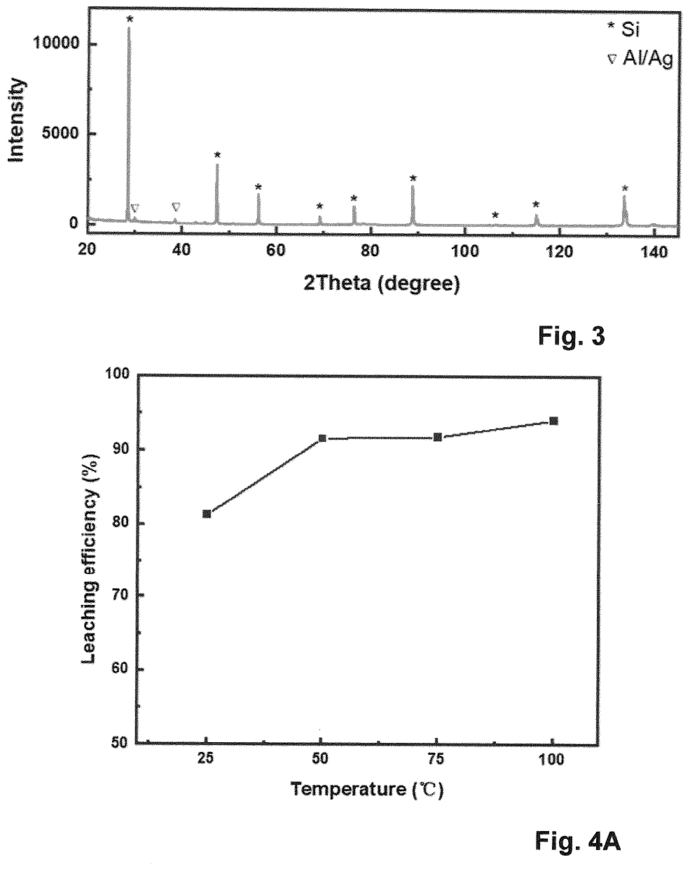

FIG. 3 shows an X-Ray Diffraction (XRD) of the granular mass including Si and Ag in the environment of FIG. 2B. Referring to FIGS. 1-3, as the disclosed recycling process is aimed to process the low purity mixed powder from mechanical pretreatment, it is preferable that the granular mass of solar cells is first ball milled by a planetary ball mill machine. FIG. 3 presents the corresponding XRD pattern, which shows main Si peaks with two small Al or Ag peaks at 30 and 39 degrees. Table 1 shows an ICP-OES (inductively coupled plasma optical emission spectroscopy) analysis of the granular mass (scraps):

TABLE I

| Element: | Si | Ag | Al | B | P | Pb | Cu |
|---|---|---|---|---|---|---|---|
| Weight % | 94.32 | 0.59 | 5.05 | 0.01 | 0.01 | 0.01 | 0 |

A significant challenge in recycling solar panels through mechanical pretreatment is the purity of the recycled materials. Unlike waste solar cells treated thermally or chemically, materials such as Ag, Al, and SiNx cannot be removed sequentially via etching. Furthermore, extracting boron (B) and phosphorus (P) proves to be problematic. The disclosed approach preserves silicon while eliminating other elements, complicating integration with simpler pretreatment techniques. The alkaline leaching process (212) dissolves most components of the solar cells into a solution while producing hydrogen gas. This allows for the extraction of significant elements through pH adjustments. Not only does this process yield high-purity products, but it also generates hydrogen gas, which may be harvested for various applications in many industrial applications including fuel cells and steel production.

In this leaching process 212, Ag does not react with NaOH solution. Although there is no evidence proving whether B and P at the atomic level react with NaOH, they can be effectively separated from Si regardless of their reactivity with the NaOH solution. If B and P react with NaOH and dissolve in the solution, their anions will not be precipitated during pH adjustment. And if they remain in the filter cake along with Ag, they will not compromise the purity of recovered Si product. Further, NH₃ gas may be adsorbed and collected by passing a water tank. As a result, the final Si-based (silica) product 120 and H₂ gas 116 byproduct achieved through this method attain high purity and are suitable for various downstream industrial applications.

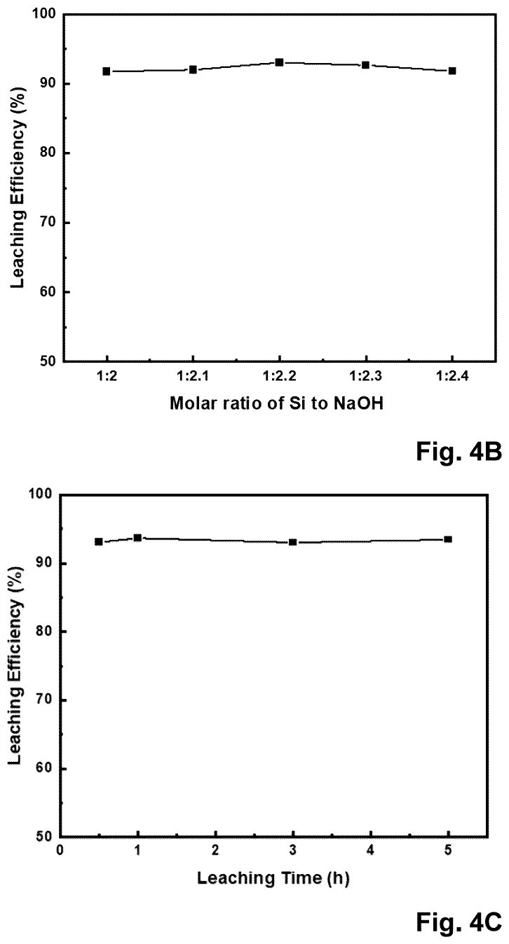

FIGS. 4A-4D show leaching parameters and effectiveness of leaching with a strong base as in FIGS. 1-3. Referring to FIGS. 1-4D, FIGS. 4A-4D demonstrate Si leaching efficiencies by varying leaching temperatures (FIG. 4A); the molar ratio of Si to NaOH (FIG. 4B); leaching time of NaOH solution (FIG. 4C) and with different concentrations of NaOH solution (FIG. 4D).

The effects of temperature are depicted in FIG. 4A, where a 1:1 molar ratio of Si to NaOH was achieved using a 10 wt. % NaOH solution for a ½ hour reaction. At 25° C., the leaching efficiency of Si is only 81.26% and when the temperature increased to 50° C. and 75° C., the efficiency is increased to 91.58% and 91.76%, respectively. The leaching efficiency reaches a peak of 94.02% at 100° C. Considering the energy cost and leaching efficiency, the optimized temperature is set at 50° C.

For operation under 50° C. and ½ hour reaction time, the molar ratio of Si and NaOH is shown in FIG. 4B. The leaching efficiency changes little with change the molar ratio of Si and NaOH. However, a trend of initially increasing and then decreasing is observed. The leaching efficiency reaches its peak of 93.04% at the 1:2.2 molar ratio of Si to NaOH. Thus, the 1:2.2 molar ratio of Si to NaOH is selected as the optimized molar ratio, however ratios in the range of 1:2 and 1:2.4 should be effective. Subsequently, the leaching time was tested with 1:2.2 molar ratio of Si to NaOH under 50° C. in FIG. 4C. The leaching efficiency increases to 93.68% when the leaching time increases from ½ hour to 1 hour. And then, the leaching efficiency is reduced slightly as the leaching time increases because of the formation of the hydroxy sodalite zeolite. Hence, a preferable leaching time was fixed at 1 hour. Then, the concentration of NaOH solution is depicted in FIG. 4D, driven by the amount of water. As equations (1) and (3) above show, H₂O is significant and also affects the modulus of Na₂SiO₃ leading to different leaching efficiency. As depicted in FIG. 4D, 10 wt. % of NaOH has the highest leaching efficiency compared to 5 wt. % and 15 wt. %. Thus, the optimal leaching conditions are 10 wt. % of NaOH solution with the 1:2.2 molar ratio of Si to NaOH under 50 C for 1 hour. Under the optimal leaching conditions, the maximum Si leaching efficiency reaches 93.68%.

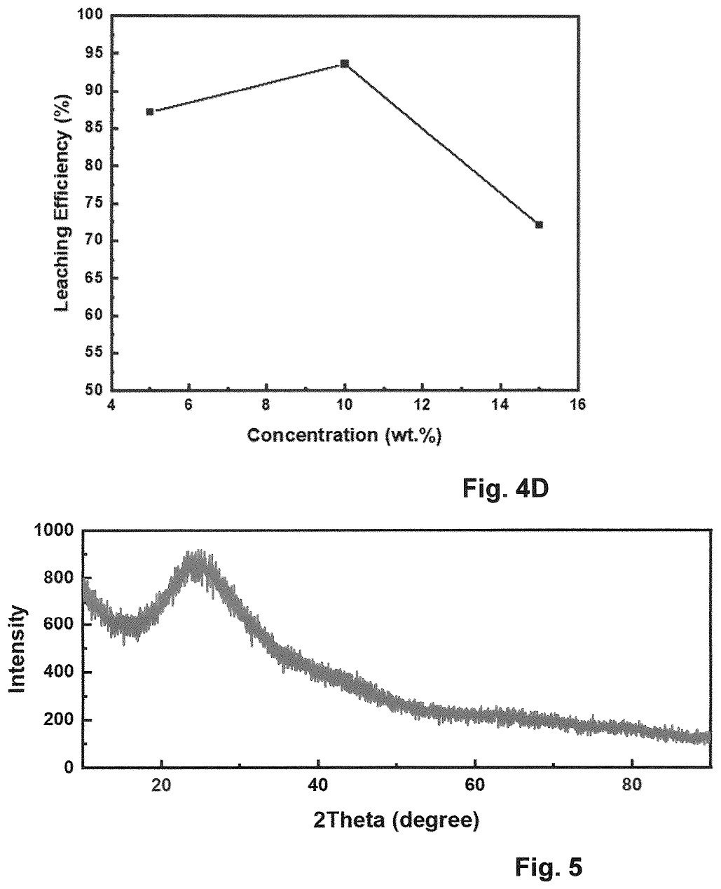

FIG. 5 shows an XRD analysis of the recovered SiO₂ using the approach of FIGS. 1-3. Referring to FIGS. 1-5, from the leach solution, the high purity SiO₂ is precipitated by adjusting pH downward through addition of HCl (hydrochloric) or a similar acid. In a particular configuration, to achieve high purity, the pH was adjusted to 1 to keep Al ions in the solution. Al is classified as an amphoteric metal, meaning it can react with both acids and bases. In the disclosed process, aluminum initially leaches into the solution with NaOH. When the pH is adjusted from an alkaline state to an acidic state, Al ions will first precipitate as Al(OH)₃ and then dissolve back into the solution as AICl₃.

However, during the precipitation process 220, SiO₂ initially forms a hydrogel, leading to the remaining Al impurities in the water phase. Thus, the obtained SiO₂ gel was first dried in the oven and washed 2 times by DI water to remove the Al impurities. The recovered SiO₂ forms nano size particles with few, if any, impurities detected. The corresponding XRD pattern in FIG. 5 presents an amorphous structure of SiO₂ without any impurity peaks. To further confirm the purity of recovered SiO₂, ICP-OES (Table II) was utilized to confirm that B and Pb have been substantially removed from recovered SiO₂. The main impurity elements are Al and Na, taking 0.0040 wt. % and 0.0016 wt. %, respectively, which is possible to be removed by optimizing the washing process. Additionally, the final recycling rate is 92.74% and the purity of recovered SiO₂ is 99.994%, which identifies as high purity silica.

TABLE II

| Element: | Na | Ag | Al | B | P | Pb | Cu |
|---|---|---|---|---|---|---|---|
| Weight %: | 0.0016 | 0 | 0.003955 | 0 | 0 | 0 | 0 |

The disclosed approach is an innovative green technology for recycling solar cell waste. We introduced a simple yet effective alkaline leaching process that not only recycles and refines solar cell materials but also generates hydrogen gas as a green byproduct. Configurations herein demonstrate remarkable efficiency reacting with a 1:2.2 molar ratio of silicon and 10 wt. % NaOH at 50° C. for one hour, that achieves a leaching efficiency of 93.68%. The overall recycle rate is 92.74% and the resultant SiO₂ exhibited exceptional purity at 99.994%, making it highly suitable for various applications across electronics, biotechnology, optical fibers, and lithium-ion battery industries. Harvesting of silver and hydrogen gas further supports feasibility, and elimination of the need for hydrofluoric acid (HF) marks a substantial improvement over conventional approaches.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for recycling solar panels for obtaining purified silicon, comprising:
agitating a recycling stream of solar panels for generating a granular mass of silicon based powders;
adding a base to the granular mass to form a leach solution with a pH for leaching silicon from the granular mass; and
adding an acid to the leach solution to reduce the pH of the leach solution for precipitating recycled silicon.

2. The method of claim 1 comprising adding an acid to the granular mass of silicon based powders, before adding the base, to reduce impurities in the granular mass.

3. The method of claim 1 wherein the recycled silicon is in the form SiO₂.

4. The method of claim 1 wherein the base is a sodium hydroxide solution.

5. The method of claim 1 wherein the sodium hydroxide solution has a concentration between 5%-25%.

6. The method of claim 1 wherein the molar ratio of silicon to sodium hydroxide in the leach solution is between 1:2 and 1:2.4.

7. The method of claim 1 wherein the acid is hydrochloric acid, the hydrochloric acid reducing the pH of the leach solution to lower than 4.0.

8. The method of claim 1 wherein the pH of the leach solution is reduced to between 1.0-2.0 for precipitating the recycled silicon while maintaining residual aluminum in solution.

9. The method of claim 1 further comprising separating the granular mass based on a particle size for removing casing, electrical connectors and adhesive polymers.

10. The method of claim 9 further comprising sieving the granular mass for separating silicon containing solar cell particles.

11. The method of claim 1 wherein the recycled silicon has a purity of at least 99.99%.

12. The method of claim 1 wherein the recycling rate of silicon from the granular mass is at least 92%.

13. The method of claim 1 further comprising, prior to adding the base to the granular mass, adding an acid for an acid wash to remove impurities selected from the group consisting of B, Cu, Al, P, Na, Pb, Fe, S and Ag.

14. A method of recycling and repurposing solar panel waste, comprising:
agitating solar panels from a waste stream of discarded solar panels for forming a granular mass including silicon;
combining the granular mass in an enclosure with a strong base for inducing dissolution of at least the Si;
adjusting the pH for inducing precipitation of the silicon; and
gathering the precipitated silicon.

15. The method of claim 14 wherein the precipitated silicon takes the form of SiO₂.

16. The method of claim 14 wherein the strong base is sodium hydroxide, further comprising adjusting the pH by adding an acid for lowering the pH.
